(19) United States
(12) Patent Application Publication
(10) Pub. No.: US 2005/0066357 A1
(43) Pub. Date: Mar. 24, 2005

(54) Modifying content rating

(76) Inventor: Kim Annon Ryal, Poway, CA (US)

Correspondence Address: MILLER PATENT SERVICES, 2500 DOCKERY LANE, RALEIGH, NC, 27606, US

(21) Appl. No.: 10/667,614

(22) Filed: Sep. 22, 2003

(51) Int. Cl. H04N 7/025; H04N 7/16; H04N 7/10

(52) U.S. Cl. 725/35; 725/32; 725/36

(57) ABSTRACT

A method of modifying content in a manner consistent with certain embodiments involves determining that the content has a content rating which is greater than a specified content rating limit; identifying at least one segment of the content to be replaced; obtaining at least one segment of replacement content to substitute for the segment content to be replaced, wherein the replacement content meets criteria for a content rating which is no greater than the specified content rating limit; and replacing the at least one segment of content to be replaced with the at least one segment of replacement content. This abstract is not to be considered limiting, since other embodiments may deviate from the features described in this abstract without departing from certain embodiments.

### CROSS REFERENCE TO RELATED DOCUMENTS

This application is related to U.S. Ser. No. 10/319,066 filed Dec. 13, 2002 entitled “Content Replacement by PID Mapping” to Candelore, et al. which is hereby incorporated herein by reference.

### BACKGROUND

Parental (or other supervisory) control over content viewed by children, for example, can be exercised in several ways. Using “V-Chip” enabled devices, programming having a content rating outside of user specified limits can be blocked. Other solutions have been devised to block only objectionable portions of content provided on DVD (Digital Versatile Disc). Each of these approaches blocks or skips content which may limit programming options or cause a loss of continuity of program material.

### BRIEF DESCRIPTION OF THE DRAWINGS

Certain exemplary embodiments may be best understood by reference to the following detailed description taken in conjunction with the accompanying drawings in which:

FIG. 1 illustrates replacement of content in a data stream in a manner consistent with certain embodiments of the present invention.

FIG. 2 is a flow chart describing a content replacement process consistent with certain embodiments of the present invention.

FIG. 3 is another flow chart describing a content replacement process consistent with certain embodiments of the present invention.

FIG. 4 is a block diagram of an illustrative television Set-Top Box consistent with certain embodiments of the present invention.

FIG. 5 is a block diagram of another illustrative television Set-Top Box consistent with certain embodiments of the present invention.

FIG. 6 is a block diagram of a content decoder consistent with certain embodiments of the present invention.

FIG. 7 is a flow chart of a process for replacement content and filter data generation consistent with certain embodiments of the present invention.

### DETAILED DESCRIPTION

There is shown in the drawings and will herein be described in detail specific embodiments, with the understanding that the present disclosure is to be considered as exemplary and is not intended to limit the invention to the specific embodiments shown and described. In the description below, like reference numerals are used to describe the same, similar or corresponding parts in the several views of the drawings.

For purposes of the present description, the term “Set-Top Box” refers to a television Set-Top Box (STB) device such as those used to tune, receive, decrypt, and/or decode transmissions from cable or satellite television distribution systems, as well as other types of STB devices including, but not limited to disc drive based personal video recorders (PVR) and other similar devices that can receive and decode digital audio/video (A/V) content such as MPEG (Moving Pictures Expert Group) encoded signals used to encode digital television or movies. Moreover, it is widely contemplated that the functionality of such devices will be incorporated within television receivers, thus, certain embodiments consistent with the present invention should not be construed limited to those realized within an STB type device.

The above-referenced patent application contains certain embodiments which utilize multiple Packet Identifiers (PID) in a stream of digital content (e.g., MPEG compliant digital content) to provide for substitution of one segment of content for another. Some of the technology described in these applications are applicable to certain embodiments consistent with the present invention.

Certain types of content, such as movies, have an associated content rating established by a supervisory body to inform potential viewers of the type of material that may form a part of the content. Ratings of G, PG, PG-13, R and NC-17 are commonly established for most movies produced in the United States by the Classification and Ratings Administration (CARA) of the Motion Picture Association (MPA) or the Motion Picture Association of America (MPAA). Television programming is similarly rated by the TV Parental Guidelines Monitoring Board, which provides ratings of TV-Y, TV-Y7, TV-Y7-FV, TV-G, TV-14 and TV-MA.

For purposes of this document, content having a rating provided under such rating systems will be referred to as having a “higher” rating if it is intended for more mature audience, and a “lower” rating if it is intended for a more general or less mature audience (i.e., the above ratings are listed from lowest to highest). Therefore, within this terminology, an R rating would be considered a “higher” rating than a G rating. Such nomenclature is defined herein for simplicity of description of the above rating system as well as equivalent systems, without intent for the nomenclature to pass any judgement on the quality of such content. Additionally, the term “content rating” or simply “rating” is intended to embrace any suitable content rating system, domestic or foreign, public, private or governmental which serves a similar function. Such rating information is generally provided as data embedded within the movie's vertical blanking interval or using other program specific information or tabulated in an EPG (Electronic Programming Guide) when the movie is stored or transmitted.

Many parents, and others in a supervisory capacity, would like to have the ability to prevent unauthorized viewing of programming (e.g., movies) which contain certain types of content. For example, certain movies may contain nudity, violence, harsh language or explicit sexual content are generally deemed to have a relatively high rating, for example, of R whereas programming directed to smaller children might have a relatively lower rating of G. However, in many cases, the parent may not mind if the vast majority of a particular movie were viewed by their children, even though it might have a rating that exceeds that which they would normally find acceptable, so long as the objectionable portions are not viewed. Often, only a few scenes contain objectionable material. If such material were altered or omitted from the movie, the parent might have no objection to the viewing of the content. Others, for religious or personal reasons, may not wish to be exposed to such material themselves. (Thus, the example used herein of a parent that wishes to control viewing by a child is merely illustrative and in no way limiting.)

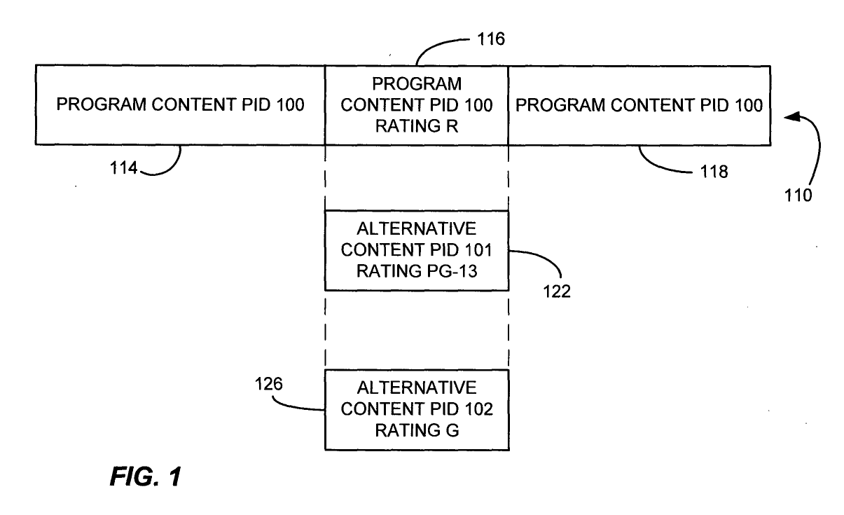

Turning now to FIG. 1, a mechanism for substitution of portions of content based upon a rating system can be understood by viewing a stream 110 of digital video (e.g., MPEG encoded) content. In this simple example, the video stream contains program content which has been assigned a packet identifier (PID) of value 100 in order to identify packets in a transport stream which are associated with this particular video stream. In this simple example, the stream of content is divided into three segments 114, 116 and 118. Consider the example wherein content stream 110 carries a rating of “R” which would suggest that there is at least one segment of content, in this case assume segment 116, which contains material deemed unsuitable for viewing by less mature audiences. In this case, one or more segments of substitute content 122 and 126 can be used as substitutes for the objectionable segment 116. For instance, segment 122 can be provided in which the R rated content is replaced with content which is rated “PG-13”. This segment of replacement content 122 can be identified by using a different PID such as 101. Similarly, segment 126 can be provided in which the “R” rated content is replaced with content which is rated “G”. This segment of replacement content 126 can be identified by using a different PID such as 102.

While segments of content, per se, are not conventionally rated, there are criteria established for what types of content would generally be suitable for each particular content rating grade. Of course, such ratings are somewhat subjective, but by conservative application of such criteria, it is possible to provided replacement content segments which would, if they were part of the original content, have rendered the original content suitable for receipt of a lower rating. Thus, consistent with certain embodiments, the replacement content can be created to effectively a lower rating of the overall main content when the replacement is implemented by editing, manipulating or re-enacting the objectionable segments. In other embodiments, the effective rating can be reduced by substituting packets in which the video is blanked, censored or re framed to produce a lower rating. Audio packets can be generated which are over-dubbed with audio, censored by masking with a beep or tone or other sound to eliminated the objectionable material or simply blanked by omitting the objectionable audio. Any combination of the above techniques can also be used.

In order to make the substitution of content, the segment 116 is removed from the video stream and one of the replacement segments 122 or 126 can be inserted in it's place. This can be accomplished in the case of MPEG encoded video data by using an MPEG splice function, for example.

Generally speaking, the replacement data can downloaded from the Internet or obtained as packaged media or received by any other suitable mechanism in which an MPEG adaptation field can be used to store time stamp information used as a filter to determine locations in the original program content (stream 110) in which the replacement content 122 or 126 should be substituted in the original content.

Thus, a method of modifying content in a manner consistent with certain embodiments involves determining that the content has a content rating which is greater than a specified content rating limit; identifying at least one segment of the content to be replaced; obtaining at least one segment of replacement content to substitute for the segment content to be replaced, wherein the replacement content meets criteria for a content rating which is no greater than the specified content rating limit; and replacing the at least one segment of content to be replaced with the at least one segment of replacement content.

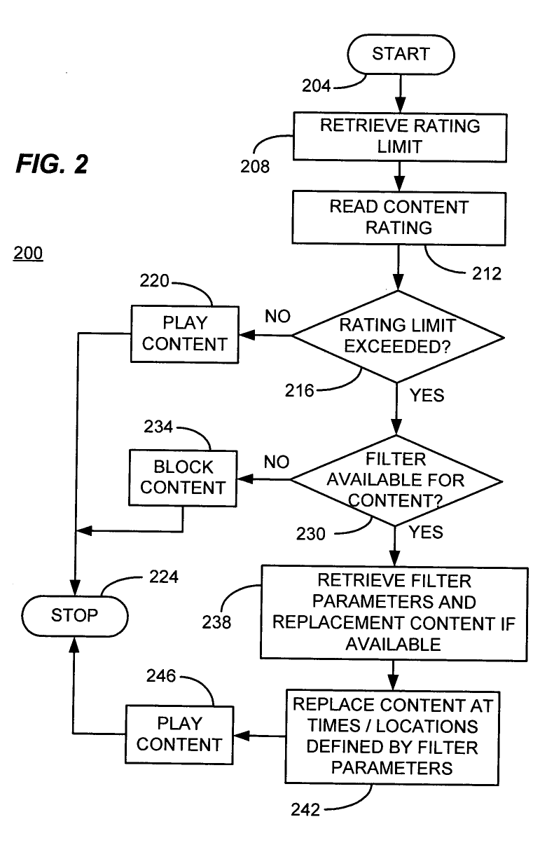

FIG. 2 shows a more detailed process 200 for modifying content as described above starting at 204. At 208 a rating limit (which is defined by the user to establish the maximum permissible content rating for viewing) is retrieved from memory or a storage device such as a disc drive. This rating limit may be input by the user depending upon the viewing audience or may be determined by entries made to set up an entitlement package associated with receipt of the program content. At 212, the content rating is determined, for example, by reference to electronic program guide material or by reading embedded content rating data or using any other suitable technique for ascertaining a particular content rating. The content rating and rating limit are then compared at 216 to determine whether or not the content is suitable for viewing, as determined by use of the rating limit as a standard. If the content rating is less than or equal to the rating limit, the content is simply played in a normal fashion at 220 until the content ends at 224.

If, however, the rating limit is exceeded by the content rating at 216, the process determines at 230 if a suitable content filter is available (e.g., in the form of a segment of content identified as replacement content for the content of interest in which suitable start and stop time stamps are available). If not, the content is blocked at 234 and the process ends at 224. In this manner, objectionable content for which a suitable filter is not available is blocked so that younger viewers (for example) are not inadvertently exposed to the content.

If a filter is available at 230 for this particular content, the filter and replacement content is retrieved (e.g., from a disc drive, an optical disc or downloaded from an Internet site) at 238. The content is then replaced at the times or other defined locations (e.g., packet numbers) as defined by the filter parameters at 242. Since the replacement content may have a different PID than the original content, and since some decoders may only be able to decode data streams having a single PID (or set of PIDs) the replacement process of 242 may incorporate a remapping of the PID of the replacement content so that the replacement content has the same PID as the original content. The content, having replaced segments can then be played at 246 in a normal manner until the process ends at 224.

Thus, as described above, a method of modifying content consistent with certain embodiments involves determining that the content has a content rating which is greater than a specified content rating limit; determining if a filter is available for the content; and if a filter is not available for the content, blocking the content. If a filter is available for the content, the process involves identifying at least one segment of the content to be replaced; obtaining at least one segment of replacement content to substitute for the segment content to be replaced, wherein the replacement content meets criteria for a content rating which is no greater than the specified content rating limit; and replacing the at least one segment of content to be replaced with the at least one segment of replacement content.

Another method of modifying content consistent with certain embodiments involves determining that the content has a content rating which is greater than a specified content rating limit; identifying at least one segment of the content to be replaced by retrieving a filter for the content, wherein the filter specifies a location for each of the at least one segment of content; obtaining a segment of replacement content corresponding to each segment of content to be replaced, wherein the replacement content meets criteria for a content rating no greater than the specified content rating; and replacing each segment of content to be replaced with the corresponding segment of replacement content.

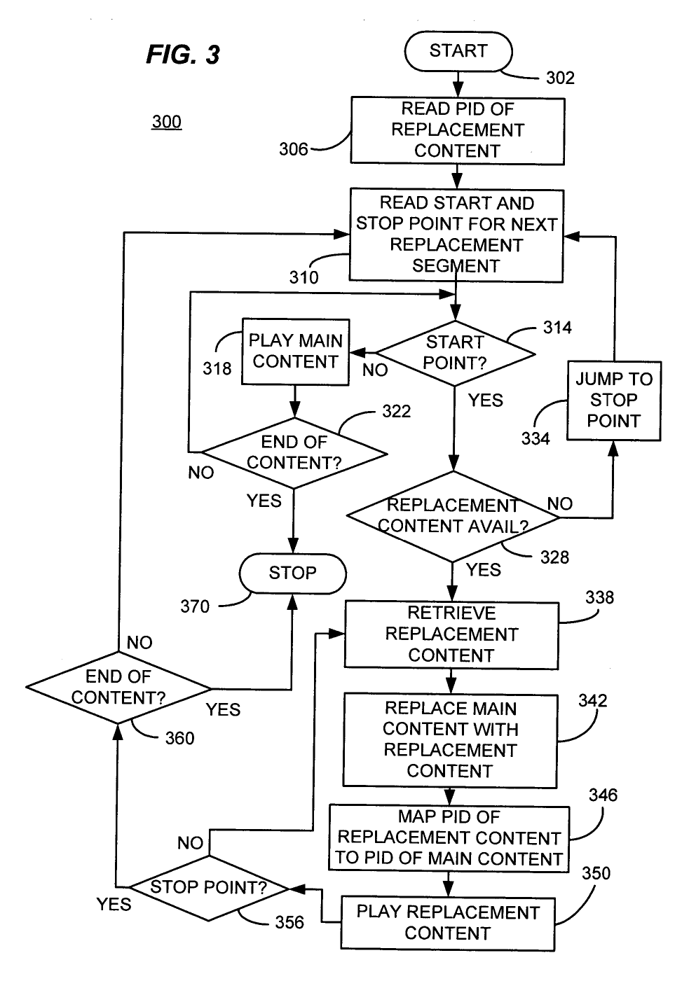

A more detailed view of a routine for carrying out content substitution in a manner consistent with certain embodiments of the present invention is depicted as process 300 of FIG. 3 starting at 302. At 306, the PID value of the main content and the replacement content are read or otherwise determined. At 310, the start and stop points (or other time or location identifier data) is read from the filter parameters for the first (or next) segment of replacement content. At 314, the process determines whether or not the start point has been reached (or in the case of the first replacement segment, whether or not the replacement content is at the start of the main content). If not, the main content is played at 318.

If the end of the main content is reached at 322, control passes to 370. If the end of the content has not been reached at 322, control returns to 314 to determine if the start point for the next segment of replacement content has been reached. When this start point for the next segment of replacement content is reached at 314 the replacement content is checked at 328 to determine that it is available and usable (i.e., not corrupted in some manner). If the content is not usable or available for whatever reason (including presence of only filter data and not replacement content), the process jumps to the stop point so that the objectionable material is effectively removed for playback at 334.

If, however, the replacement content is available at 328, the replacement content is retrieved at 338 and is used to replace the removed main content at 342. The PID of the replacement content is mapped to the PID of the main content at 346 and the content is sent to a decoder at 350 for play of the replacement content. Control then returns to 338 until the stop point is reached at 356. Assuming the end of the content has not been reached at 360 (in which case the process ends at 370), the process returns to 310 to begin the process for replacement of the next segment of content.

Therefore, in the manner described, a method of modifying content consistent with certain embodiments involves identifying the content by a first Packet Identifier (PID); obtaining a content rating for the content; obtaining a specified content rating limit; determining that the content has a content rating which is greater than the specified content rating limit; identifying a plurality of segments of the content to be replaced by retrieving a filter for the content, wherein the filter specifies a location for each of the segments of content; obtaining a plurality of segments of replacement content corresponding to the plurality of segments of content to be replaced, wherein the segments of replacement content each meet criteria for having a content rating no greater than the specified content rating, and wherein the replacement content is identified by a second PID; and replacing each of the plurality of segments of content to be replaced with the corresponding segments of replacement content.

The method of modifying content can be carried out in a television Set-Top Box, in certain exemplary embodiments, by (for example) identifying the content by a first Packet Identifier (PID); obtaining a content rating for the content; obtaining a specified content rating limit from a stored value; determining that the content has a content rating which is greater than a specified content rating limit; determining if a filter is available for the content; if a filter is not available for the content, blocking the content. If a filter is available for the content, the process can proceed by downloading the filter; using the filter to identify at least one segment of the content to be replaced; downloading at least one segment of replacement content to substitute for the segment content to be replaced, wherein the replacement content meets criteria for a content rating which is no greater than the specified content rating limit, and wherein the replacement content is identified by a second PID; wherein the at least one segment of replacement content contains time stamps that define start times and stop times for substitution of each of the at least one segment of replacement content for the at least one segment of content to be replaced and wherein the time stamps are carried in an MPEG adaptation field; replacing the at least one segment of content to be replaced with the at least one segment of replacement content, wherein the replacing is carried out using an MPEG splice function; and mapping the at least one segment of replacement content from the second PID to the first PID.

The filter information, as disclosed above, can be supplied in many suitable formats including, but not limited to, the method described above wherein the filter information is embedded within a transport stream carrying the replacement content. In other embodiments, however, a separate table or listing of start and stop points, packet numbers or other equivalent data can be supplied without departing from certain embodiments.

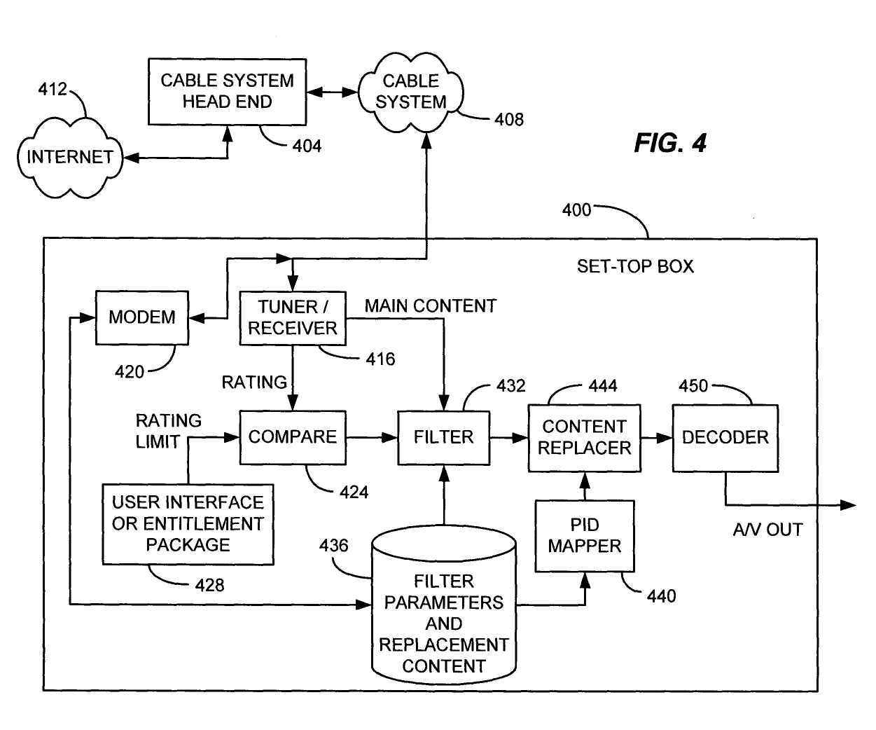

FIG. 4 shows one embodiment of a television STB 400 that can be used to implement processes consistent with certain embodiments. Those skilled in the art will appreciate upon consideration of the present teaching that such STB 400 may be configured in many variations and may incorporate one or more processors operating under program control to implement one or more of the functions described herein. In this illustrative embodiment, a cable system head end 404 serves as a Multiple Service Operator (MSO) providing television programming to the STB 400 via a cable system network 408. Head end 404 may also serve as a source of access to the Internet 412 and may thus provide the services equivalent to those of an Internet Service Provider (ISP) to STB 400 in certain embodiments. Television programming are received by STB 400 through tuner and receiver circuitry 416 used to tune to individual television channels. Additionally, an internal (or external) modem 420, such as a DOCSIS compliant modem, may be connected to the cable system to adapt the cable system to data communication.

The receiver circuit 416 strips rating information from the transport stream associated with a particular channel (or otherwise obtains the rating, e.g., from EPG data) and provides that information to comparison circuit 424. Comparison circuit 424 is used to carry out a comparison of the rating with the rating limit information stored at 428 as a result of user input or stored as a result setup of an entitlement package for the cable system. The result of the comparison is provided to a filter 432 that takes the main content from the tuner/receiver 416 and filters the content if the rating of the content exceeds the rating limit.

The filtering is carried out on the basis of filter parameters received, for example, via modem 420, and stored on a storage device such as a disc drive 436. Such filter parameters are provided to the filter 432 so that packets of data corresponding to segments of objectionable content are removed from the main content data stream. Replacement content, for example stored on storage device 436, is provided to a PID mapper 440 that maps the replacement content's PID to the same PID as that of the main content. This replacement content is then supplied to a content replacer 444 that places the replacement content in the data stream—preferably at the location where the objectionable content was removed. The modified content is then supplied to a decoder 450 for decoding into AN data that can be presented to the user (e.g., NTSC or PAL video).

In this manner, a content decoding device consistent with certain embodiments has a comparing circuit that compares a content rating of the content with a specified content rating limit. A filter identifies a location in the content of at least one segment of the content to be replaced. A content replacer replaces the at least one segment of content to be replaced with at least one segment of replacement content, wherein the replacement content meets criteria for a content rating which is no greater than the specified content rating limit.

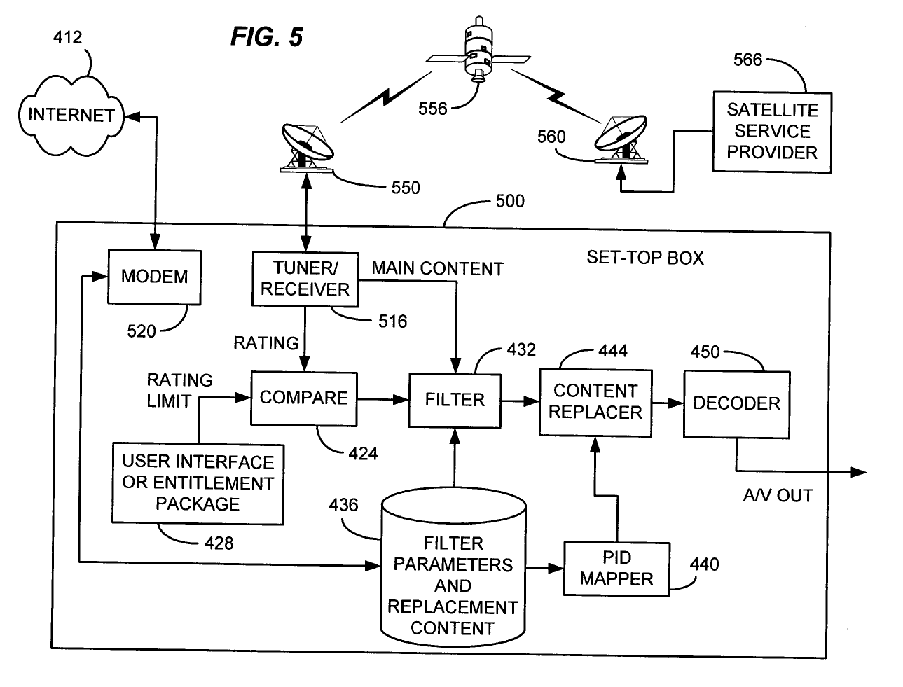

While the above example depicts use of certain embodiments in connection with a cable television network signal, this should not be considered limiting since the process can be adapted to a variety of different realizations. In FIG. 5, a satellite television system embodiment of a television STB is depicted as 500. In this illustrative embodiment, the STB 500 operates in a manner similar to that of STB 400 except that modem 520 is depicted as being connected to the Internet 412 via a separate connection (e.g., DSL, T1, cable or dial-up). This, however is not to be limiting since this variation is only one of many variations, and in other embodiments the Internet connection could be obtained via the satellite link.

In FIG. 5, tuner/receiver 516 is connected to a satellite antenna 550 incorporating a low-noise block (LNB) circuit and further incorporates other conventional satellite receiver circuitry. Antenna 550 receives programming content and other associated data from a satellite 556 which receives the programming content and other associated data from one or more land based transmitting antennas 560 connected to one or more satellite service providers 566. Otherwise, operation of this embodiment can be similar to that of STB 400.

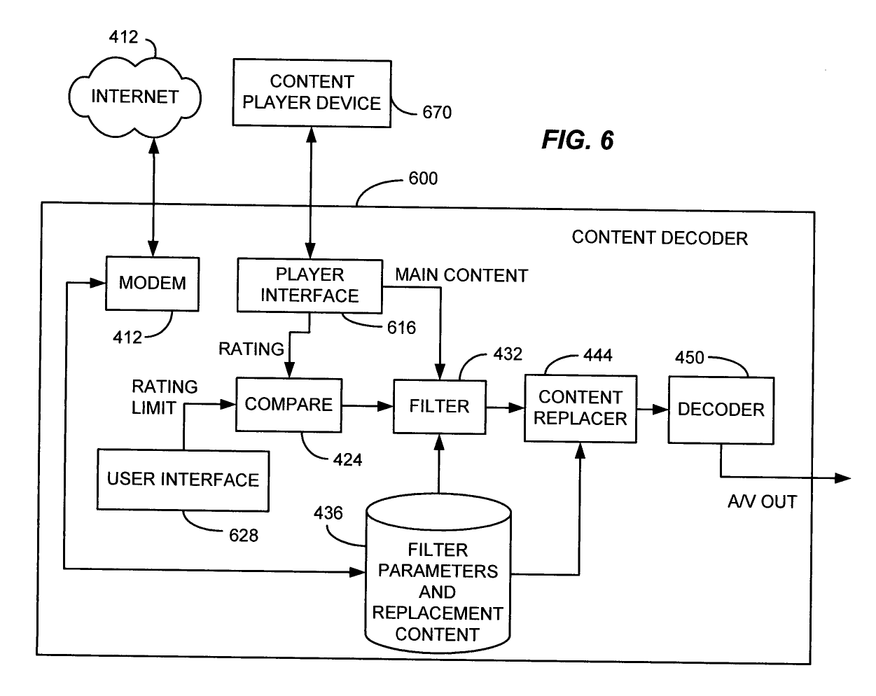

In FIG. 6, a content decoder 600 implements a similar process for content supplied by an internal or external content player device 670 (e.g., a DVD player, PVR or similar devices). The output of the content player device 670 is coupled to an interface 616 that supplies rating information to compare circuit 424 and the main content data stream to filter 432. In this illustrative embodiment, the STB 600 operates in a manner similar to that of STB 400 except that modem 520 is again depicted as being connected to the Internet 412 as shown (e.g., DSL, cable or dial-up). This embodiment may also be arranged to require a rating limit as an input from user interface 628, which may be password protected to facilitate parental control. Moreover, storage medium 436 could be the same storage medium as that used to store the main content (e.g., in the case of a PVR). Otherwise, operation of this embodiment can be similar to that of STB 400, except that the main content source can be packaged media such as DVD or other such media.

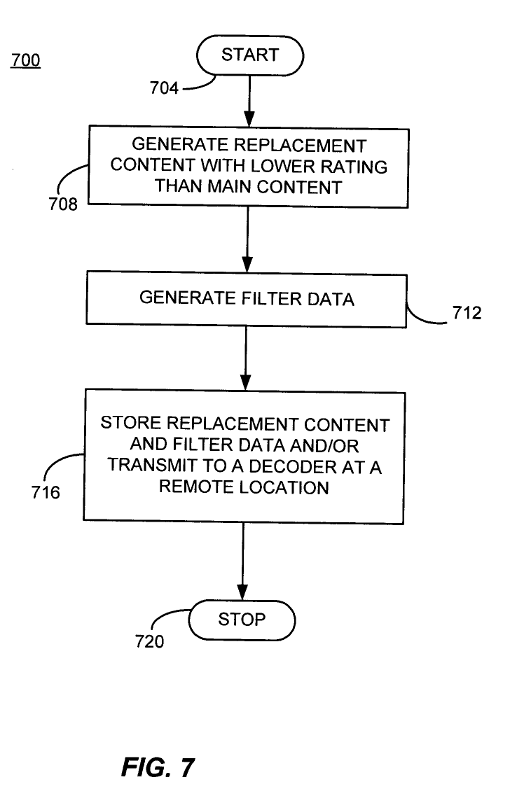

FIG. 7 depicts an exemplary process 700 for generation of the filter data and replacement content starting at 704. At 708, replacement content is generated in which the replacement content meets criteria for a lower rating than the main content. At 712, filter data are generated wherein such filter data define the starting and stopping points for the content replacement. At 716, the replacement content can be stored in a computer readable storage medium and/or can be transmitted to a decoder device such as 400, 500 or 600 from a remote location for use in the processes described above or equivalent. The process ends at 720.

Thus, a method of producing replacement content for replacement of segments of main content consistent with certain embodiments involves generating segments of replacement content corresponding to segments of main content, wherein the segments of replacement content meet criteria for a lower content rating than that of the main content; generating filter data that identifies starting points and stopping points in the main content for substitution of the replacement data for the main content; and storing the filter data and the replacement content as one or more computer readable data.

In another embodiment, a method of producing replacement content for replacement of segments of main content, involves generating segments of replacement content corresponding to segments of main content, wherein the segments of replacement content meet criteria for a lower content rating than that of the main content; generating filter data that identifies starting points and stopping points in the main content for substitution of the replacement data for the main content; and transmitting the filter data and the replacement content to a remotely located decoding device.

In certain embodiments, the main content is identified by a first Packet Identifier (PID) and the replacement content can be identified by a second PID. The filter data can include time stamps that define start times and stop times for replacement of the segment of replacement content for the segment of content to be replaced. Such time stamps can be carried in an MPEG adaptation field.

Those skilled in the art will recognize that certain embodiments have been described based upon use of a programmed processor. However, other embodiments could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments.

Those skilled in the art will appreciate that the program steps and associated data used to implement the embodiments described above can be implemented using disc storage for 436 as well as other forms of computer readable storage devices such as for example Read Only Memory (ROM) devices, Random Access Memory (RAM) devices; optical storage elements, magnetic storage elements, magneto-optical storage elements, flash memory, core memory and/or other equivalent storage technologies. Such alternative storage devices should be considered equivalents. Moreover, the storage medium used could be a separately purchased package medium which does not utilize an Internet download to provide the filter parameters and replacement content.

Certain embodiments described herein are implemented using a programmed processor executing programming instructions that are broadly described above in flow chart form that can be stored on any suitable computer readable storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

While specific embodiments have been described, it is evident that many alternatives, modifications, permutations and variations will become apparent to those skilled in the art in light of the foregoing description.

1. A method of modifying content, comprising:
determining that the content has a content rating which is greater than a specified content rating limit;
identifying at least one segment of the content to be replaced;
obtaining at least one segment of replacement content to substitute for the segment content to be replaced, wherein the replacement content meets criteria for a content rating which is no greater than the specified content rating limit; and
replacing the at least one segment of content to be replaced with the at least one segment of replacement content.

2. The method according to claim 1, wherein the content is identified by a first Packet Identifier (PID), and wherein the replacement content is identified by a second PID.

3. The method according to claim 2, further comprising mapping the at least one segment of replacement content from the second PID to the first PID.

4. The method according to claim 1, wherein the obtaining is carried out by a download from the Internet.

5. The method according to claim 1, wherein the obtaining is carried out by retrieving the replacement content from a computer readable storage medium.

6. The method according to claim 1, wherein the at least on segment of replacement content contains time stamps that define a start time and a stop time for replacement of each of the at least one segment of replacement content for the at least one segment of content to be replaced.

7. The method according to claim 6, wherein the time stamps are carried in an MPEG adaptation field and wherein the substitution is carried out using an MPEG splice function.

8. The method according to claim 1, wherein the specified content rating limit is obtained from entries made by a user.

9. The method according to claim 1, wherein the specified content rating limit comprises a stored value established as part of a content entitlement package.

10. The method according to claim 1, carried out in a content decoding device.

11. The method according to claim 1, carried out in a television Set-Top Box.

12. The method according to claim 1, wherein the replacement content contains video which is blanked, censored or re-framed to produce a lower rating, and wherein the replacement content contains audio which is blanked, over-dubbed or censored by masking with a sound.

13. A computer readable storage medium storing instructions which, when executed on a programmed processor, carry out a process of modifying content according to claim 1.

14. A method of modifying content, comprising:
determining that the content has a content rating which is greater than a specified content rating limit;
determining if a filter is available for the content;
if a filter is not available for the content, blocking the content;
if a filter is available for the content:
identifying at least one segment of the content to be replaced;
obtaining at least one segment of replacement content to substitute for the segment content to be replaced, wherein the replacement content meets criteria for a content rating which is no greater than the specified content rating limit; and
replacing the at least one segment of content to be replaced with the at least one segment of replacement content.

15. The method according to claim 14, wherein the content is identified by a first Packet Identifier (PID), and wherein the replacement content is identified by a second PID.

16. The method according to claim 15, further comprising mapping the at least one segment of replacement content from the second PID to the first PID.

17. The method according to claim 14, wherein the obtaining is carried out by a download from the Internet.

18. The method according to claim 14, wherein the obtaining is carried out by retrieving the replacement content from a computer readable storage medium.

19. The method according to claim 14, wherein the at least on segment of replacement content contains time stamps that define a start time and a stop time for replacement of each of the at least one segment of replacement content for the at least one segment of content to be replaced.

20. The method according to claim 19, wherein the time stamps are carried in an MPEG adaptation field and wherein the substitution is carried out using an MPEG splice function.

21. The method according to claim 14, wherein the specified content rating limit is obtained from entries made by a user.

22. The method according to claim 14, wherein the specified content rating limit comprises a stored value established as part of a content entitlement package.

23. The method according to claim 14, carried out in a television Set-Top Box.

24. The method according to claim 14, carried out in a content decoding device.

25. A computer readable storage medium storing instructions which, when executed on a programmed processor, carry out a process of modifying content according to claim 14.

26. A method of modifying content, comprising:
determining that the content has a content rating which is greater than a specified content rating limit;
identifying at least one segment of the content to be replaced by retrieving a filter for the content, wherein the filter specifies a location for each of the at least one segment of content;
obtaining a segment of replacement content corresponding to each segment of content to be replaced, wherein the replacement content meets criteria for a content rating no greater than the specified content rating; and
replacing each segment of content to be replaced with the corresponding segment of replacement content.

27. The method according to claim 26, wherein the content is identified by a first Packet Identifier (PID), and wherein the replacement content is identified by a second PID.

28. The method according to claim 27, further comprising mapping the at least one segment of replacement content from the second PID to the first PID.

29. The method according to claim 26, wherein the obtaining is carried out by a download from the Internet.

30. The method according to claim 26, wherein the obtaining is carried out by retrieving the replacement content from a computer readable storage medium.

31. The method according to claim 26, wherein the at least one segment of replacement content contains time stamps that define a start time and a stop time for replacement of each at least one segment of replacement content for the at least one segment of content to be replaced.

32. The method according to claim 31, wherein the time stamps are carried in an MPEG adaptation field and wherein the substitution is carried out using an MPEG splice function.

33. The method according to claim 26, wherein the specified content rating limit is obtained from entries made by a user.

34. The method according to claim 26, wherein the specified content rating limit comprises a stored value established as part of a content entitlement package.

35. The method according to claim 26, carried out in a television Set-Top Box.

36. The method according to claim 26, carried out in a content decoding device.

37. The method according to claim 26, wherein the replacement content contains video which is blanked, censored or re-framed to produce a lower rating, and wherein the replacement content contains audio which is blanked, over-dubbed or censored by masking with a sound.

38. A computer readable storage medium storing instructions which, when executed on a programmed processor, carry out a process of modifying content according to claim 26.

39. A method of modifying content, comprising:
identifying the content by a first Packet Identifier (PID);
obtaining a content rating for the content;
obtaining a specified content rating limit;
determining that the content has a content rating which is greater than the specified content rating limit;
identifying a plurality of segments of the content to be replaced by retrieving a filter for the content, wherein the filter specifies a location for each of the segments of content;
obtaining a plurality of segments of replacement content corresponding to the plurality of segments of content to be replaced, wherein the segments of replacement content each meet criteria for having a content rating no greater than the specified content rating, and wherein the replacement content is identified by a second PID; and
replacing each of the plurality of segments of content to be replaced with the corresponding segments of replacement content.

40. The method according to claim 39, further comprising mapping the plurality of segments of replacement content from the second PID to the first PID.

41. The method according to claim 39, wherein the obtaining is carried out by a download from the Internet.

42. The method according to claim 39, wherein the obtaining is carried out by retrieving the replacement content from a computer readable storage medium.

43. The method according to claim 39, wherein the specified content rating limit is obtained from entries made by a user.

44. The method according to claim 39, wherein the specified content rating limit comprises a stored value established as part of a content entitlement package.

45. The method according to claim 39, wherein the segments of substitute content contains time stamps that define start times and stop times for substitution of each segment of substitute data for the segments of content to be replaced.

46. The method according to claim 39, wherein the time stamps are carried in an MPEG adaptation field and wherein the substitution is carried out using an MPEG splice function.

47. The method according to claim 39, carried out in a television Set-Top Box.

48. The method according to claim 39, carried out in a content decoding device.

49. A computer readable storage medium storing instructions which, when executed on a programmed processor, carry out a process of modifying content according to claim 39.

50. A method of modifying content in a television Set-Top Box, comprising:
identifying the content by a first Packet Identifier (PID);
obtaining a content rating for the content;
obtaining a specified content rating limit from a stored value;
determining that the content has a content rating which is greater than a specified content rating limit;
determining if a filter is available for the content;
if a filter is not available for the content, blocking the content;
if a filter is available for the content:
downloading the filter;
using the filter to identify at least one segment of the content to be replaced;
downloading at least one segment of replacement content to substitute for the segment content to be replaced, wherein the replacement content meets criteria for a content rating which is no greater than the specified content rating limit, and wherein the replacement content is identified by a second PID;
wherein the at least one segment of replacement content contains time stamps that define a start time and a stop time for replacement of each of the at least one segment of replacement content for the at least one segment of content to be replaced and wherein the time stamps are carried in an MPEG adaptation field;
replacing the at least one segment of content to be replaced with the at least one segment of replacement content, wherein the replacing is carried out using an MPEG splice function; and
mapping the at least one segment of replacement content from the second PID to the first PID.

51. A content decoding device, comprising:
a comparing circuit that compares a content rating of the content with a specified content rating limit;
a filter that identifies a location in the content of at least one segment of the content to be replaced; and
a content replacer that replaces the at least one segment of content to be replaced with at least one segment of replacement content, wherein the replacement content meets criteria for a content rating which is no greater than the specified content rating limit.

52. The content decoding device according to claim 51, wherein the content is identified by a first Packet Identifier (PID), and wherein the replacement content is identified by a second PID.

53. The content decoding device according to claim 52, further comprising a PID mapper that maps the at least one segment of replacement content from the second PID to the first PID.

54. The content decoding device according to claim 51, wherein the at least one segment of replacement content contains time stamps that define a start time and a stop time for replacement of each at least one segment of replacement content for the at least one segment of content to be replaced.

55. The content decoding device according to claim 54, wherein the time stamps are carried in an MPEG adaptation field and wherein the substitution is carried out using an MPEG splice function.

56. The content decoding device according to claim 51, further comprising a modem, and wherein the replacement content is obtained by a download from the Internet.

57. The content decoding device according to claim 51, further comprising a computer readable storage medium, and wherein the replacement content is retrieved from the computer readable storage medium.

58. The content decoding device according to claim 51, further comprising a user interface, and wherein the specified content rating limit is obtained from entries made by a user.

59. The content decoding device according to claim 51, further comprising a storage device, and wherein the specified content rating limit comprises a value stored on the storage device that is established as part of a content entitlement package.

60. The content decoding device according to claim 51, further comprising a content player device supplying the content.

61. The content decoding device according to claim 51, further comprising a receiver that receives the content from one of a satellite television distribution network and a cable system distribution network.

62. The content decoding device according to claim 51, embodied within a television Set-Top Box.

63. A data signal, comprising:
a segment of replacement content for use in replacing main content, wherein the main content has a specified content rating and wherein the segment of replacement content meets criteria for a lower content rating; and
filter data identifying a segment of main content for which the segment of replacement content replaces.

64. The data signal according to claim 63, wherein the main content is identified by a first Packet Identifier (PID), and wherein the replacement content is identified by a second PID.

65. The data signal according to claim 63, stored on a computer readable storage medium.

66. The data signal according to claim 63, wherein the filter data comprises time stamps that define start time and stop time for replacement of the segment of replacement content for the segment of content to be replaced.

67. The data signal according to claim 66, wherein the time stamps are carried in an MPEG adaptation field.

68. A method of producing replacement content for replacement of segments of main content, comprising:
generating segments of replacement content corresponding to segments of main content, wherein the segments of replacement content meet criteria for a lower content rating than that of the main content;
generating filter data that identifies starting points and stopping points in the main content for substitution of the segments of replacement content for the main content; and
storing the filter data and the segments of replacement content as one or more computer readable data.

69. The method according to claim 68, wherein the main content is identified by a first Packet Identifier (PID), and further comprising identifying the replacement content by a second PID.

70. The method according to claim 68, wherein the filter data comprises time stamps that define start times and stop times for replacement of the segments of replacement content for the segments of content to be replaced.

71. The method according to claim 70, wherein the time stamps are carried in an MPEG adaptation field.

72. The method according to claim 68, wherein the replacement content contains video which is blanked, censored or re-framed to produce a lower rating, and wherein the replacement content contains audio which is blanked, over-dubbed or censored by masking with a sound.

73. A method of producing replacement content for replacement of segments of main content, comprising:
generating segments of replacement content corresponding to segments of main content, wherein the segments of replacement content meet criteria for a lower content rating than that of the main content;
generating filter data that identifies starting points and stopping points in the main content for substitution of the segments of replacement content for the main content; and
transmitting the filter data and the segments of replacement content to a remotely located decoding device.

74. The method according to claim 73, wherein the main content is identified by a first Packet Identifier (PID), and further comprising identifying the replacement content by a second PID.

75. The method according to claim 73, wherein the filter data comprises time stamps that define start times and stop times for replacement of the segments of replacement content for the segments of content to be replaced.

76. The method according to claim 75, wherein the time stamps are carried in an MPEG adaptation field.

77. The method according to claim 73, wherein the replacement content contains video which is blanked, censored or re-framed to produce a lower rating, and wherein the replacement content contains audio which is blanked, over-dubbed or censored by masking with a sound.
